(19) United States
(12) Patent Application Publication
(10) Pub. No.: US 2025/0316017 A1
(43) Pub. Date: Oct. 9, 2025

(54) HIERARCHICAL SPARSE VOXEL REPRESENTATION FOR GENERATING SYNTHETIC SCENES

(71) Applicant: NVIDIA Corporation, Santa Clara, CA (US)

(72) Inventors: Seung Wook KIM, Toronto (CA); Karsten Julian KREIS, Vancouver (CA); Antonio TORRALBA BARRIUSO, Somerville, MA (US); Kangxue YIN, Toronto (CA); Sanja FIDLER, Toronto (CA)

(73) Assignee: NVIDIA Corporation, Santa Clara, CA (US)

(21) Appl. No.: 18/625,837

(22) Filed: Apr. 3, 2024

(51) Int. Cl. G06T 15/08; G06T 1/20; G06T 3/40; G06T 7/50; G06T 9/00; G06T 17/00; G06V 10/77

(52) U.S. Cl. CPC G06T 15/08; G06T 1/20; G06T 3/40; G06T 7/50; G06T 9/00; G06T 17/00; G06V 10/7715; G06T 2200/04; G06T 2207/10028; G06T 2207/20084

(57) ABSTRACT

In various examples, systems and methods are disclosed relating to generating each initial feature map of a plurality of initial feature maps based on a respective input image of an input dataset, each initial feature map, incorporating depth data of the respective input image, corresponds to a plurality of pixels of the respective input image, generating a sparse feature point cloud including a plurality of features determined using the plurality of initial feature maps, transforming the sparse feature point cloud into multi-resolution sparse grids, each of the multi-resolution sparse grids comprising a plurality of voxels, modeling, using a plurality of neural networks according to a hierarchal architecture, the multi-resolution sparse grids to construct a hierarchical volume representation, and providing constructed content based on the hierarchical volume representation.

### BACKGROUND

Traditionally, three-dimensional scene construction methods, including Neural Radiance Fields and 3D Gaussian Splats, require iterative optimization schemes to construct a 3D representation of the target scene. This limits their applicability to perform other tasks such as online surround view visualization and generative modeling. Traditional 3D scene generative models such as 3D diffusion models require an explicit data representation, such as 3D voxel grids.

Performance of diffusion model-based 3D scene generation is influenced by the degree to which the data representation encodes scene details. Additionally, due to memory constraints, the diffusion model-based 3D scene generation methods often only use smaller voxel grid representations (e.g., 128×128×32), thereby limiting the ability of the models to capture fine(r) scene details.

### SUMMARY

Approaches in accordance with various embodiments relate to systems, methods, and non-transitory computer-readable media for improving the efficiency and memory usage in 3D scene generation, such as one-shot 3D scene generation from 2D images. In some embodiments, a pipeline for constructing a hierarchical voxel representation of a 3D environment is provided. The hierarchical voxel representation can be used for reconstructing a surround view (e.g., for an ego vehicle or a character), for example. The improved 3D scene generation architecture enables one-shot prediction without iterative optimization, allowing for the prediction and construction of a 3D representation for any given image in a single step. A hierarchical voxel representation can be constructed in one shot from a set of given input images. In some examples, the hierarchical voxel representation can be used in scene construction. Thus, improved 3D scene representation inference architecture described herein require significantly less memory and less processing to operate as compared to traditional 3D scene generation models. Although currently available memory devices (e.g., memory of a graphics processing unit (GPU)) are difficult to store one a large number of voxels needed for traditional 3D scene generation models, the improved 3D scene generation architecture described herein specifies voxels (e.g., volumetric pixels) in a hierarchical manner, such that only occupied voxels are stored to reduce computation requirements, especially during a volume rendering process where only the voxels that are occupied or filled are queried.

At least one aspect relates to at least one processor. The processor can include one or more circuits to construct each initial feature map of a plurality of initial feature maps based on a respective input image of an input dataset, with each initial feature map incorporating depth data of the respective input image and corresponding to a plurality of pixels of the respective input image. The one or more circuits of the processor may also, in one or more embodiments, construct a sparse feature point cloud including a plurality of features determined using the plurality of initial feature maps, and transform the sparse feature point cloud into multi-resolution sparse grids, each of the multi-resolution sparse grids comprising a plurality of voxels. In one or more embodiments, the one or more circuits of the processor may also model, using a plurality of neural networks according to a hierarchal architecture, the multi-resolution sparse grids to construct a hierarchical volume representation, and provide constructed content based on the hierarchical volume representation.

At least one aspect relates to at least one processor. The processor can include one or more circuits to determine an initial feature map based on an input dataset, wherein the initial feature map, incorporating depth data, corresponds with a plurality of pixels of the input dataset, determine a hierarchical volume representation based on multi-resolution sparse grids comprising a plurality of voxels corresponding to a transformed sparse feature point cloud, and provide constructed content based on volume rendering of the hierarchical volume representation.

At least one aspect relates to at least one processor. The processor can include one or more circuits to construct, by a model using a plurality of initial feature maps and a plurality of depth maps for a plurality of input images of an input dataset, a sparse feature point cloud comprising a plurality of features of the plurality of initial feature maps, construct, by a model using the sparse feature point cloud, a plurality of sparse grids having different resolutions, combine, by a model, a plurality of features of the plurality of sparse grids to determine a hierarchical volume representation, construct, by a model, an output image using the hierarchical volume representation, wherein the output image is constructed based on a pose of a first input image of the plurality of input images, determine a loss of the output image with respect to the first input image, and update the model using the loss.

Disclosed embodiments can be included in a variety of different systems such as automotive systems having control systems for an autonomous or semi-autonomous machine (e.g., an AI driver, an in-vehicle infotainment system, and so on) and/or a perception system (e.g., sensor systems and so on) for an autonomous or semi-autonomous machine, systems implemented using a robot, aerial systems, medical systems, boating systems, smart area monitoring systems, systems for performing deep learning operations, systems for performing simulation operations, systems for generating or presenting virtual reality (VR) content, augmented reality (AR) content, and/or mixed reality (MR) content, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations, systems implementing one or more language models-such as one or more large language models (LLMs) and/or one or more vision language models (VLMs), systems for hosting real-time streaming applications, systems for performing light transport simulation, systems for performing collaborative content creation for 3D assets, systems implemented at least partially using cloud computing resources, and/or other types of systems.

### BRIEF DESCRIPTION OF THE DRAWINGS

The present systems and methods for constructing a hierarchical voxel representation of 3D environment are described in detail below with reference to the attached drawing figures, wherein:

FIG. 1 illustrates an example computing environment including a training system for training (e.g., updating) machine learning models and an application system for deploying machine learning models.

FIG. 2 is a block diagram of an example of a model for determining an output image using multi-view input dataset.

FIG. 3 is a diagram illustrating a frustum constructed using a feature map.

FIG. 4 is a block diagram of an example of a method for deploying a machine learning model to construct output image.

FIG. 5 is a block diagram of an example of a method for deploying a machine learning model to construct output image.

FIG. 6 is a block diagram of an example of a method for training a machine learning model to construct output image.

FIG. 7 is a block diagram of an example computing device.

FIG. 8 illustrates an example data center.

### DETAILED DESCRIPTION

Challenges in traditional 3D scene generation include the large volume of voxel grids required for each scene in a dataset, often numbering in the billions. Although traditional voxel grids can represent a scene with large dimensions (such as 1024×1024×128) in great detail, the resulting computational burden is tremendous—especially given that computations in voxel space grows cubically. To address this, a scene construction model described herein can produce 3D scenes using sparse voxel representations. In particular, unlike systems that iteratively update a 3D representation to produce the input image, the system described herein utilizes the depth prediction network to obtain initial depths and then sparsifies the input image into a sparse voxel grid based on the initial depth, which is then processed using a 3D neural network (e.g., Convolutional Neural Network (CNN)), resulting in a more efficient and direct process.

Another challenge that the 3D scene generation architecture described herein addresses is the efficient stitching of images from multiple cameras. The embodiments described herein address challenges—such as low-resolution images and high storage costs associated with voxel space—by creating a sparse structure that eliminates the need to store all voxel entries while establishing a hierarchical representation for information at various levels. Additionally, the 3D scene generation architecture described herein enables one-shot prediction without iterative optimization, allowing for the prediction of a 3D representation for any given image in a single step.

The 3D scene generation architecture reduces the coarseness of 3D construction by combining different levels of granularities as defined in the hierarchy, resulting in smoother and more detailed outputs. While many traditional systems have constraints on voxel size, often limited by memory capabilities of the hardware, the 3D scene generation architecture described herein introduces a sparsified structure which allows for the growth of more detailed voxels within a scene. In some embodiments, features extracted from three or more levels of a hierarchy can be concatenated, where each level can contribute to a component of a feature map. These components are composed of vector numbers and are combined during volume rendering to create a structured representation, leading to the rendering of 3D features with enhanced detail and realism.

The 3D scene generation architecture described herein is applicable to autonomous vehicle applications (e.g., training autonomous Artificial Intelligence (AI) drivers and calibrating sensors), which require highly accurate and detailed 3D representations of surroundings of autonomous vehicles to navigate safely. Traditional methods that use dense voxel grids (i.e., non-sparsified structures) often struggle to process and store the vast amount of data necessary for high-resolution 3D mappings. By utilizing the depth prediction network to obtain initial depths and then converting the initial depths into a sparse voxel grid which is processed through a 3D neural network, the 3D scene generation architecture as described herein can improve data processing process while also enabling a one-shot prediction approach. For example, the entire 3D scene can be predicted and reconstructed in a single step, significantly enhancing the efficiency and speed at which autonomous vehicles (e.g., the AI drivers thereof) can interpret complex environments, including urban landscapes with multiple moving objects, varying topography, and diverse lighting conditions. Accordingly, this one-shot capability ensures safer and more reliable navigation by allowing autonomous vehicles (e.g., the AI drivers thereof) to quickly adapt to dynamic changes in the environment. In some examples, the one-shot 3D scene generation framework uses a single forward pass of neural networks from input 2D images. This is in contrast to other scene construction methods such as Neural Radiance Fields (NeRF) that require iterative optimization scheme.

A 3D scene generation model constructs neural fields of a 3D scene, from which a 2D image can be rendered from any viewpoint corresponding to, for example, a visual image sensor (e.g., a camera) in the 3D scene. In implementations related to autonomous vehicles, an autonomous vehicle can include multiple cameras arranged thereon with different poses (e.g., positions and orientations, thus different Fields-of-Views (FOVs)). Each camera can capture a video or a sequence of images as the autonomous vehicle moves. Synthetic videos or sequence of synthetic images can be constructed from the poses of the different cameras located on an autonomous vehicle, based on which an AI driver can be trained. For example, the AI driver of the autonomous vehicle can consume such synthetic videos or sequence of synthetic images to construct instructions for various aspects (e.g., power supply, motor, steering, break, suspension, and so on) of the autonomous vehicle, and the instructions are evaluated to update the AI driver. The synthetic videos or sequence of synthetic Images are consumed instead of real-world videos/images to reduce the cost and improve the efficiency of training the AI drivers.

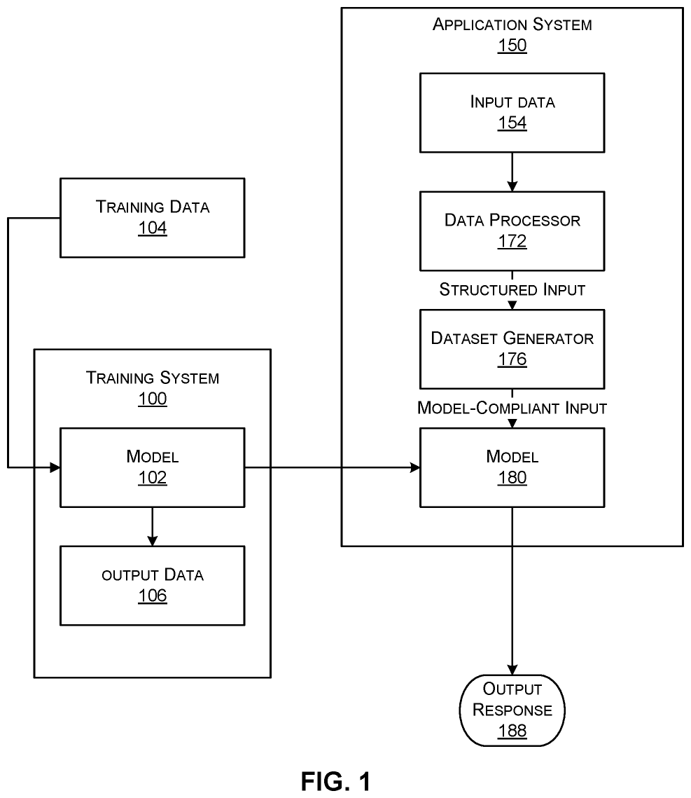

With reference to FIG. 1, FIG. 1 illustrates an example computing environment including a training system 100 for training (e.g., updating) machine learning models and an application system 150 for deploying machine learning models, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

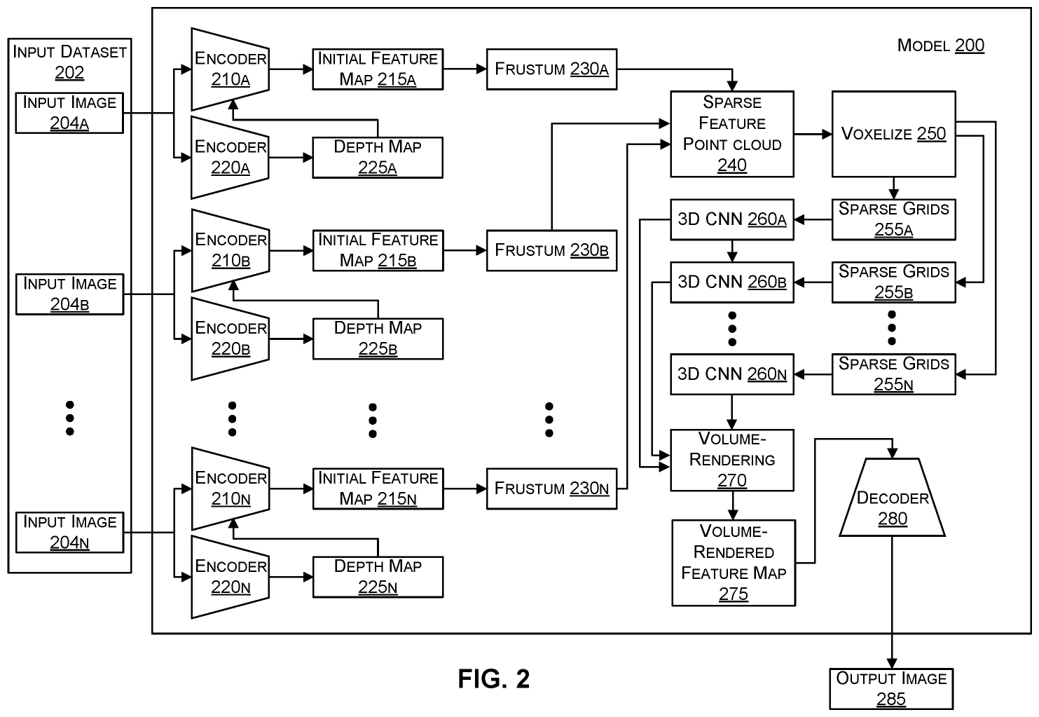

The training system 100 can train or update a model 102 (e.g., the model 200 in FIG. 2). An example of the model 102 includes one or more encoders, neural networks, CNNs, one or more residual neural networks (ResNets), other network types, transformers, or various combinations thereof, and so on. The model 102 can include one or more neural networks. A neural network such as the CNN described herein can include an input layer, an output layer, and/or one or more intermediate layers, such as hidden layers, which can each have respective nodes. Each component of the model 102 can include various neural network models, including models that are effective for operating on respective ones of 2D data, 3D data, and so on. The model 102 and the components thereof can include a scene construction model, which can include a statistical model that can generate new instances of data (e.g., new, artificial, synthetic data such as artificial, synthesized, or synthetic images or 3D representations and outputs described herein) using existing data (e.g., existing input images based on which a 3D scene is constructed). The new instances of data is referred to as output data 106, such as the output image 285.

The training system 100 can train or update the model 102 by applying as input the training data 104. The training data 104 can include the input dataset 202, as described in further details herein. The model 102 is trained or updated using the training data 104 to allow the model 102 to output the output data 106. The output data 106 can be used to evaluate whether the model 102 has been trained/updated sufficiently to satisfy a target performance metric, such as a metric indicative of accuracy of the model 102 in determining outputs. Such evaluation can be performed based on various types of loss, including the reconstruction loss. A total/aggregate loss can be calculated to be the sum or a combination of one or more of the types of loss. In some embodiments, the loss function can be constructed with any given target images. For example, for any target image x and its camera pose p, volume rendering can be performed on the hierarchical voxels (which is constructed based on a set of input images) to obtain the corresponding output x′. The reconstruction loss between x′ and x can be determined and used to update the model 102 in the manner described.

For example, the training system 100 can use a function—such as a loss function (e.g., the reconstruction loss or the total loss)—to evaluate a condition for determining whether the model 102 is configured (sufficiently) to meet the target performance metric. The condition can be a convergence condition, such as a condition that is satisfied responsive to factors such as an output of the function meeting the target performance metric or threshold, a number of training iterations, training of the model 102 converging, or various combinations thereof. For example, the function can be of the form of a mean error, mean squared error, or mean absolute error function.

The training system 100 can iteratively apply the training data 104 to update the model 102, evaluate the loss responsive to applying the training data 104, and/or modify (e.g., update one or more weights and biases of) the model 102. The training system 100 can modify the model 102 by modifying at least one of a weight or a parameter of the model 102. The training system 100 can evaluate the function by comparing an output of the function to a threshold of a convergence condition, such as a minimum or minimized cost threshold, such that the model 102 is determined to be sufficiently trained (e.g., sufficiently accurate in determining outputs) responsive to the output of the function being less than the threshold. The training system 100 can output the model 102 responsive to the convergence condition being satisfied.

The application system 150 can operate or deploy a model 180 to determine responses to input data 154 (e.g., similar to the input dataset 202). The application system 150 can be a system to provide outputs (e.g., the output response 188) based on the input data 202 such as multi-view data of a physical 3D scene. The application system 150 can be implemented by or communicatively coupled with the training system 100, or can be separate from the training system 100.

The model 180 can be or be received as the model 102, a portion thereof, or a representation thereof. For example, a data structure representing the model 102 can be used by the application system 150 as the model 180. The data structure can represent parameters of the trained model 102, such as weights or biases used to configure the model 180 based on the training of the model 102.

The data processor 172 can be or include any function, operation, routine, logic, or instructions to perform functions such as processing the input data 154 to determine or construct a structured output, such as a structured image's data structure. The data processor 172 can provide the structured input to a dataset generator 176.

The dataset generator 176 can be or include any function, operation, routine, logic, or instructions to perform functions such as determining, based at least on the structured input, an input compliant with the model 180. For example, the model 180 can be structured to receive input in a particular format, such as a particular 2D data format or file type, which may be expected to include certain types of values. The particular format can include a format that is the same or analogous to a format by which the training data 104 is applied to the model 102 to train the model 102. The dataset generator 176 can identify the particular format of the model 180, and can convert the structured input to the particular format.

The data processor 172 and the dataset generator 176 can be implemented as discrete functions or in an integrated function. For example, a single functional processing unit can receive the images/videos and can construct the input to provide to the model 180 responsive to receiving the images/videos.

The model 180 can construct an output response 188 (e.g., the output image 285, and so on) responsive to receiving the input from the dataset generator 176. The output response 188 can represent a 2D image.

In some implementations, the model 102, 180, and 200 can each construct neural fields of a 3D scene, from which a 2D image can be rendered from any viewpoint corresponding to, for example, a visual image sensor (e.g., a camera) in the 3D scene. Synthetic videos or sequence of synthetic images can be constructed or constructed from the poses of the different cameras located on an autonomous vehicle, based on which an AI driver can operate or be trained. For example, the AI driver of the autonomous vehicle can consume such synthetic videos or sequence of synthetic images to construct instructions for various aspects (e.g., power supply, motor, steering, break, suspension, and so on) of the autonomous vehicle, and the instructions are evaluated to update the AI driver. Such implementations are useful for constructing a 360-degree view surrounding the autonomous vehicle, such as stitching a 360 degrees visualization to assist in automated or manual parking of the vehicle. In some implementations, the model 102, 180, and 200 can facilitate task perception in autonomous driver research, allowing an AI driver to understand the surrounding 3D scene in one-shot manner. The models model 102, 180, and 200 can be included in a 3D detection model and flow estimation model configured to instantly obtain information of the 3D scene and allow instant calculation and object detection and provision of surrounding view visualization, which is not possible using the iterative methods which require significant time to calibrate.

FIG. 2 is a block diagram of an example of the model 200 for determining an output image 285 using multi-view input dataset 202, according to various embodiments. Each block shown in FIG. 2, described herein, can include one or more types of data or one or more types of computing processes that may be performed using any combination of hardware, firmware, and/or software. For instance, various functions may be carried out by a processor executing instructions stored in memory. The model 200 includes one or more of encoders 210a, 210b, . . . , 210n, encoders 220a, 220b, . . . , 220n, a voxelization function 250, a CNN 260, and a decoder 280. Each block shown in FIG. 2 can also be embodied as computer-usable instructions stored on computer storage media. Each block shown in FIG. 2 can be provided by a standalone application, a service or hosted service (standalone or in combination with another hosted service), or a plug-in to another product, to name a few. In addition, each block shown in FIG. 2 is described, by way of example, with respect to the system of FIG. 1. However, these blocks can additionally or alternatively be executed by any one system, or any combination of systems, including, but not limited to, those described herein.

FIG. 2 illustrates a single forward pass of neural networks of the model 200 (e.g., the model 102 or 180) from input 2D input dataset 202 (e.g., the input data 154) to determine the output image 285 (e.g., the output response 188). This is in contrast to other scene construction methods such as NeRF that require iterative optimization schemes in which multiple iterations are needed to determine the output image. The inputs into the model 200 include the input dataset 202, which includes a plurality of input images 204a, 204b, . . . , 204n (e.g., contents of a real-life 3D scene). In some embodiments, the input dataset 202 includes multi-view inputs. For example, the input images 204a, 204b, . . . , 204n are images (e.g., RGB images) capturing a same real-life, physical 3D scene using cameras arranged with different poses. That is, each of the input images 204a, 204b, . . . , 204n is captured from a pose k different from that of another input image. In some examples, the input images 204a, 204b, . . . , 204n include multi-view images collected or otherwise obtained at each of a plurality of timestamps. In some examples, the input dataset 202 can include a plurality of input multi-view videos defined by a sequence of the images captured at different poses and at multiple timestamps. In implementations related to autonomous vehicles, an autonomous vehicle can include multiple cameras arranged thereon with different poses (e.g., positions and orientations, thus different Fields-of-Views (FOVs)). Each camera can capture a video or a sequence of images (corresponding to a respective one of the input images 204a, 204b, . . . 204n) as the autonomous vehicle moves.

The input dataset 202 is applied as input into a feature encoder (e.g., the encoders 210a, 210b, . . . , 210n). As shown, each of the input images 204a, 204b, . . . , 204n is inputted into a respective one of the encoders 210a, 210b, . . . , 210n to construct an output including initial feature maps 215a, 215b, . . . , 215n, respectively. Although multiple encoders 210a, 210b, . . . , 210n as shown to process the input images 204a, 204b, . . . , 204n in parallel, two or more of the input images 204a, 204b, . . . , 204n can be processed using a same feature encoder in sequence, or all of the input images 204a, 204b, . . . , 204n can be processed using one feature encoder in sequence. Each of the encoders 210a, 210b, . . . , 210n can include a 2D CNN encoder or a scene auto-encoder. For example, each of the encoders 210a, 210b, . . . , 210n processes a respective one of the input images 204a, 204b, . . . , 204n (e.g., the input images 204a, 204b, . . . , 204n are processed separately) to construct a respective one of the initial feature maps 215a, 215b, . . . , 215n. Each of the initial feature maps 215a, 215b, . . . , 215n includes a 2D tensor having dimensions of [symbol] ^{H×W×(D+C)}, where H and W are smaller than a size or dimension of a corresponding input image based on which the initial feature map is constructed. In some examples, each of the initial feature maps 215a, 215b, . . . 215n includes at least one feature (e.g., a vector of numbers) for each pixel of a corresponding one of the input images 204a, 204b, . . . , 204n based on which the initial feature map is constructed.

The input dataset 202 is applied as input into a depth prediction network (e.g., the depth encoders 220a, 220b, . . . , 220n). As shown, each of the input images 204a, 204b, . . . , 204n is input into a respective one of the encoders 220a, 220b, . . . 220n to construct an output including depth maps 225a, 225b, . . . , 225n (e.g., depth data, initial depth, and so on), respectively. Although multiple encoders 220a, 220b, . . . , 220n as shown to process the input images 204a, 204b, . . . , 204n in parallel, two or more of the input images 204a, 204b, 204n can be processed using a same depth encoder in sequence, or all of the input images 204a, 204b, . . . , 204n can be processed using one depth encoder in sequence. Each of the encoders 220a, 220b, . . . , 220n can include a depth prediction network that can predict a depth (e.g., a depth value) of each pixel of an image. For example, each of the encoders 220a, 220b, . . . , 220n processes a respective one of the input images 204a, 204b, . . . , 204n (e.g., the input images 204a, 204b, . . . , 204n are processed separately) to construct a respective one of the depth maps 225a, 225b, . . . , 225n. Each of depth maps 225a, 225b, . . . , 225n includes a depth value for each pixel of a corresponding one of the input images 204a, 204b, . . . , 204n based on which the depth map is constructed. In some examples, the encoders 220a, 220b, . . . , 220n are pre-trained models (e.g., a MiDaS depth encoder) that output depth data based on input of images.

Each of the initial feature maps 215a, 215b, . . . , 215n and a corresponding one of the depth maps 225a, 225b, . . . , 225n constructed using the same input image 204a, 204b, . . . , or 204n are combined to form a respective one of the frustums 230a, 230b, . . . , 230n. In other words, each of the initial feature maps 215a, 215b, . . . , 215n is lifted (e.g., using Lift-Splat-Shoot (LSS)) using a corresponding one of the depth maps 225a, 225b, . . . , 225n constructed using the same input image 204a, 204b, . . . , or 204n into a corresponding one of the frustums 230a, 230b, . . . , 230n. For example, the depth map 225a is provided to the encoder 210a as a bias, condition, or parameter to influence the outcome of the initial feature map 215a, such that the initial feature map 215a incorporates the depth map 225a. Similarly, the initial feature map 215b incorporates the depth map 225b, . . . , and the initial feature map 215n incorporates the depth map 225n. Each of the frustums 230a, 230b, . . . , 230n includes image features and density values for each pixel of the input image based on which the frustum is constructed, along a predefined discrete set of D depths. Each of the frustums 230a, 230b, . . . , 230n is a discrete frustum (with discrete elements) having a size of H×W×D with the camera pose k for a corresponding input image 204a, 204b, . . . , 204n.

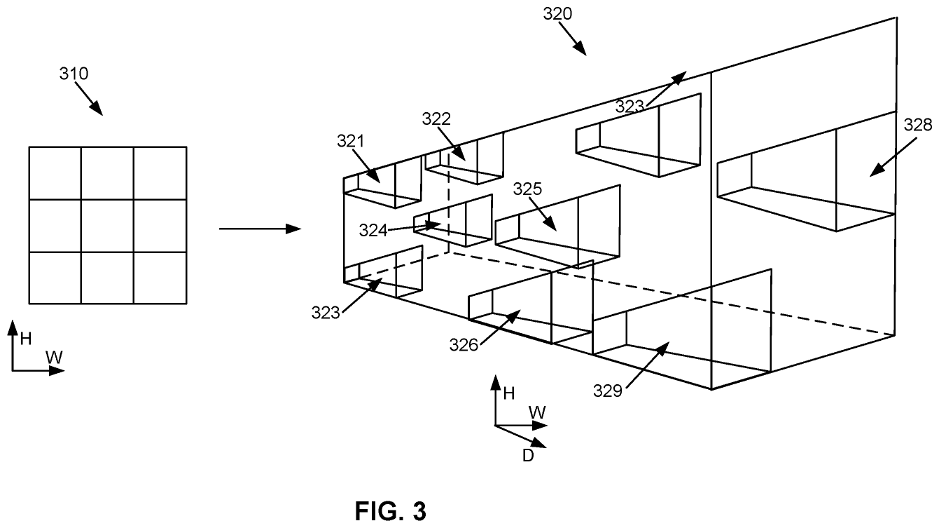

FIG. 3 is a diagram illustrating a frustum 320 constructed using a feature map 310, according to various embodiments. The frustum 320 is a simplified example of each of the frustums 230a, 230b, . . . , 230n. The feature map 310 is a simplified example of each of the initial feature maps 215a, 215b, . . . , 215n. Each block within the feature map 310 corresponds to a pixel in the input image, and has a value corresponding to the image feature and a value corresponding the density. The feature map 310 has a size of H×W, and the frustum 320 has a size of H×W×D, adding the depth dimension D corresponding to the depth dimension along which the depth data of the depth maps 225a, 225b, . . . , 225n is obtained. Conceptually, a ray from each block (or pixel) of the feature map 310 (e.g., feature space) is projected into a 3D space of the frustum 320, where the directions of the rays are defined by the pose k of the camera based on which the corresponding input image 204a, 204b, . . . , or 204n is captured. Such rays define or are within the FOV of the camera with which the input image is captures. In other words, the values of the pixels of the feature map 310 are voxelized or discretized into different entries 321, 322, 323, 324, 325, 326, 327, and 328 (or discrete elements or voxels) of the frustum 320 based on the rays. Each entry, discrete element, or voxel of the frustum 320 is identified using an index or identifier. In some examples, the value of each pixel in the feature map 310 can be splits into multiple entries in the frustum 320 along a direction of that ray.

As shown, the frustrum 320 is not entirely populated in this process. Some but not all of the entries of the frustrum 320 are populated based on the feature map 310. The values of the feature map 310 corresponding to depths that are within a range of depths can be used to fill corresponding entries of the frustrum 320, and values of the feature map 310 corresponding to depths that are outside of that range are omitted and not included in the frustrum 320, and therefore are not stored or not further processed. Accordingly, the depth maps 225a, 225b, . . . , 225n are used to determine which values of the pixels of the initial feature maps 215a, 215b, . . . , 215n are included in the frustums 230a, 230b, . . . , 230n. In some examples, the entries of the frustum 320 with the depth closest to or at the predicted depths of detected objects as defined in the depth maps 225a, 225b, . . . , 225n are filled, and other entries of the frustum 320 are left unfilled. The depth range for a pixel can be set to include the predicted depth of each detected object at that pixel. In the example in which the predicted depth of a detected object at a pixel of the input image is 11 meters, the depth range (e.g., 10-12 meters) can include a margin (e.g., 1 meter) greater than or less the predicted depth, or the depth range (e.g., 10-15 meters) is one of a plurality of predefined depth ranges (e.g., 0-5 meters, 5-10 meters, 10-15 meters, and so on). The sparsity of the frustrum 320 can be greater than 80%, 90%, 95%, or so on.

The partially filled frustums 230a, 230b, . . . , 230n are combined or merged to construct the spare feature point cloud 240 (or sparse point cloud, a sparse voxel grid, and so on). The voxels of the frustums 230a, 230b, . . . , 230n have physical meaning and are in the same coordinate system as the 3D scene captured using the input images 204a, 204b, . . . , 204n. Given that the poses of the cameras capturing an input images 204a, 204b, . . . , 204n are known, the voxels of the frustums 230a, 230b, . . . , 230n can be merged using as reference points the poses of the respective cameras capturing the input images 204a, 204b, . . . , 204n to construct the spare feature point cloud 240 within a unified coordinate system. For example, the first terms of each of the frustums 230a, 230b, . . . , 230n for the input images 204a, 204b, . . . , 204n having different poses can be merged. The spare feature point cloud 240 can also be referred to as shared voxel grid. For example, the spare feature point cloud 240 can include voxels, the feature for each of which is obtained by combining or merging (e.g., adding) the features (e.g., the values) of the frustums 230a, 230b, . . . , 230n at that position in the spare feature point cloud 240. Each feature of the spare feature point cloud 240 includes a vector of numbers.

The resulting spare feature point cloud 240 is likewise sparse, given that the source information of the frustums 230a, 230b, . . . , 230n is sparse. Instead of keeping all entries of the frustums 230a, 230b, . . . , 230n and the sparse feature point cloud 240, only entries (e.g., voxels) that are occupied are stored, thus greatly improving storage and computation efficiency. For example, the spare feature point cloud 240 can include a plurality of points that correspond to a 3D scene. Values for a large number of those points are left unfilled. The sparsity of the spare feature point cloud 240 can be greater than 80%, 90%, 95%, or so on. The spare feature point cloud 240 and the frustums 230a, 230b, . . . , 230n are referred to as spare structures that significantly reduces computation and storage costs.

The feature point cloud 240 are voxelized at 250 into multi-resolution sparse grids (e.g., the sparse grids 255a, 255b, . . . , 255n). The sparse grids 255a, 255b, . . . , 255n have different resolutions and form a multi-resolution hierarchy, to provide different types and levels of details of the 3D scene. For example, the sparse grid 255a has the highest resolution (e.g., 1024³ voxels for the 3D scene, smallest voxel size, highest granularity), the sparse grid 255b has the second highest resolution (e.g., 256³ voxels, second smallest voxel size, second highest granularity), . . . and the sparse grid 225n has the lowest resolution (e.g., 64³ voxels, biggest voxel size, lowest granularity). The sparse grid 225n having the coarsest or lowest resolution can provide global properties of the 3D scene, such as the presence of a vehicle. The sparse grid 225b having higher resolution can provide group component properties of the 3D scene, such as a front portion of the vehicle. The sparse grid 225c having the highest resolution can provide detailed properties of the 3D scene, such as a handle of a door in the front portion of the vehicle.

The hierarchy of the multi-resolution sparse grids 255a, 255b, . . . , 255n represent the same objects at different levels of granularity, which is useful for the scene construction model to understand the semantics of the 3D scene and improve understanding of object placement and coherency of pixels. This allows the scene construction model to construct an object-oriented output rather than a group of pixels with no context or coherency.

Each of the sparse grids 255a, 255b, and 255n is independently processed using a respective one of 3D CNNs 260a, 260b, . . . , 260n to determine a hierarchical volume representation. In other words, the sparse grids 255a, 255b, . . . , 255n are applied as inputs into respective ones of the CNNs 260a, 260b, . . . , 260n to construct features. Each feature constructed by the CNNs 260a, 260b, . . . , 260n includes a vector of numbers. For example, the CNN 260a can process the sparse grid 255a to construct at least one feature for each voxel of a 3D space corresponding to the highest resolution (e.g., 1024³ voxels), the CNN 260b can process the sparse grid 255b to construct at least one feature for each voxel of a 3D space corresponding to the second resolution (e.g., 256³ voxels) . . . , and the CNN 260n can process the sparse grid 255n to construct at least one feature for each voxel of a 3D space corresponding to the lowest resolution (e.g., 64³ voxels). The hierarchical volume representation includes the at least one feature for the 3D space corresponding to the different resolutions of the hierarchy.

In some examples, the at least one outputted feature constructed by a CNN at a higher resolution is applied as an addition input or condition into the CNN configured to construct at least one outputted feature at the resolution of the immediate lower tier in the hierarchy to provide contextual information. For example, the at least one outputted feature constructed by the CNN 260a is provided to the CNN 260b along with the sparse grid 255b, the at least one outputted feature constructed by the CNN 260n-1 is provided to the CNN 260n along with the sparse grid 255n, and so on.

In some examples, the sparse grids 255a, 255b, and 255n are run through separate 3D CNN layers (e.g., the CNNs 260a, 260b, . . . , 260n corresponding to different resolutions, from lower resolution to higher resolution) to determine the final processed sparse grids, which are used for a volume rendering process. Each of the sparse grids 255a, 255b, and 255n is queried, and the retrieved features are concatenated together to form the volume-rendered feature map 275. In some examples, each of the CNNs 260a, 260b, . . . , 260n includes a diffusion model, which can construct an output based on inputs including random noise. In some embodiments, random noise for a first resolution is applied as input into a first depth CNN to construct the at least one feature corresponding to the first resolution (e.g., 64³ voxels), and random noise for a second resolution is applied as input into a second depth CNN to construct, conditioned on the at least one feature corresponding to the first resolution, the at least one feature corresponding to the second resolution (e.g., 256³ voxels), and random noise for a third resolution is applied as input into a third depth CNN to construct, conditioned on the at least one feature corresponding to the first resolution and the at least one feature corresponding to the second resolution, the at least one feature corresponding to the third resolution (e.g., 1024³ voxels).

Volume rendering 270 of the hierarchical volume representation including the combined outputs of the CNNs 260a, 260b, . . . , 260n is performed with respect to a target pose (e.g., of a target camera) to construct a volume-rendered feature map 275 (or a new feature map). The outputted features from the CNNs 260a, 260b, . . . , 260n are combined (e.g., concatenated) to construct the hierarchical volume representation, which is applied as input into the volume rendering 270 to construct the volume-rendered feature map 275. The volume-rendered feature map 275 therefore has one component from each level of the hierarchy (e.g., from each of the sparse grids 255a, 255b, and 255n and each of the CNNs 260a, 260b, . . . , 260n. For example, the vectors for the plurality of features constructed by the CNNs 260a, 260b, . . . , 260n are combined or merged (e.g., concatenated) to construct the hierarchical volume representation. For example, combining the vectors includes merging features constructed by the CNNs 260a, 260b, . . . , 260n. The volume rendered feature map 275 is a 2D projection of the hierarchical volume representation with respect to a target capture device (e.g., at the target pose of the target camera).

The volume rendered feature map 275 is applied as input into a decoder 280 (that includes at least one neural network in one or more embodiments), which decodes the volume rendered feature map 275 to output an output image 285, which corresponds to the pose. Examples of the decoder 280 can be a CNN decoder. The combined vectors are volume rendered at 270 and decoded using the decoder 280.

In some embodiments, the target camera pose based on which the volume rendering 270 is performed can be the same as the camera pose of one of the input images 204a, 204b, 204n. In a training pipeline, a reconstruction loss can be determined for the output image 285 with respect to the input image, where the output image 285 and the input image have the same camera pose. The model 200, e.g., one or more of the encoders 210a, 210b, . . . , 210n, the encoders 220a, 220b, . . . , 220n, the CNNs 260a, 260b, . . . , 260n, and the decoder 280 can be updated using the reconstruction loss. For examples, one or more of the encoders 210a, 210b, . . . , 210n, the encoders 220a, 220b, . . . , 220n, the CNNs 260a, 260b, . . . , 260n, and the decoder 280 can be modified (e.g., one or more weights and biases thereof can be updated) to minimize the reconstruction loss.

In some examples, an autoencoder model (including the encoders 210a, 210b, . . . , 210n) encodes multi-view input images of the input dataset 202 into 3D density and feature voxel grids such as the sparse feature point cloud 240. Each voxel in the 3D voxel grid (e.g., the sparse feature point cloud 240) has a feature vector (occupied) or is empty (e.g., not occupied). Volume rendering in voxel space can construct a 2D view (e.g., the volume-rendered feature map 275) with respect to a pose of a camera passing through each voxel in the 3D voxel grid based on the feature vector, essentially flatten the 3D voxel grid into a 2D view based on the pose of the camera. A 2D CNN decoder 280 can render the 2D view into an output image 285. Accordingly, the model 200 constructs output images 285 (which are reconstructions of input images 204a, 204b, . . . , 204n, assuming the same camera poses) using a 3D space (e.g., the 3D voxel grid) constructed from the input images 204a, 204b, . . . , 204n.

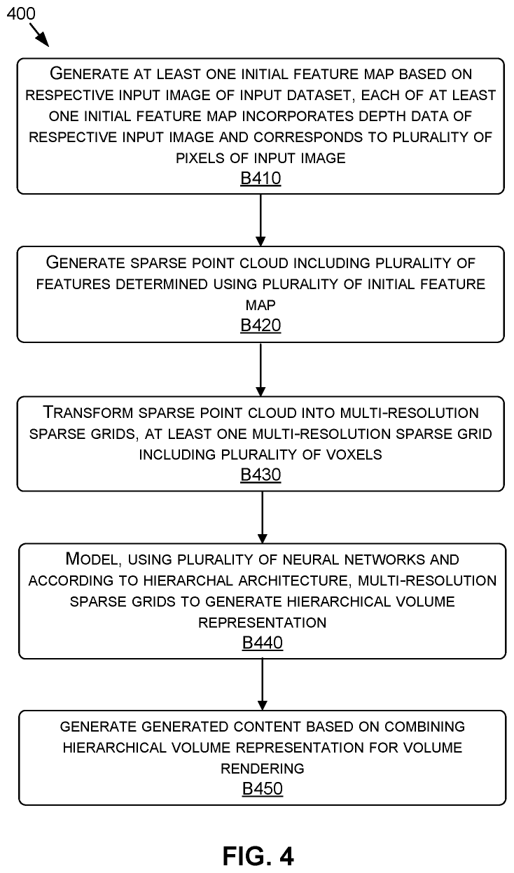

FIG. 4 is a block diagram of an example of a method 400 for deploying a machine learning model (e.g., the model 200) to construct output image 285. Each block of the method 400, described herein, can include one or more types of data or one or more types of computing processes that may be performed using any combination of hardware, firmware, and/or software. For instance, various functions may be carried out by a processor executing instructions stored in memory. The method 400 can also be embodied as computer-usable instructions stored on computer storage media. The method 400 can be provided by a standalone application, a service or hosted service (standalone or in combination with another hosted service), or a plug-in to another product, to name a few. In addition, the method 400 is described, by way of example, with respect to the system of FIG. 1 (e.g., the model 102 and 180) and FIG. 2 (e.g., the model 200). However, the method 400 can additionally or alternatively be executed by any one system, or any combination of systems, including, but not limited to, those described herein.

At 410, the model 200 (e.g., a respective one of the encoders 210a, 210b, . . . , and 210n) constructs at least one initial feature map of a plurality of initial feature maps 215a, 215b, . . . 215n based on a respective input image 204a, 204b, . . . , or 204n of the input dataset 202. Each of the at least one initial feature map incorporates depth data (e.g., the depth map 225a, 225b, or 225n) of the respective input image and corresponds to a plurality of pixels of the respective input image. In some examples, each initial feature map includes at least one feature for each pixel of the respective input image. In some examples, the input dataset 202 includes the input image 204a, 204b, . . . , or 204n of a 3D scene. In some examples, a depth encoder (e.g., an encoder 220a, 220b, . . . , or 220n) with the respective input image as input constructs a depth map (e.g., a depth map 225a, 225b, . . . , or 225n) of the respective input image. A feature encoder (e.g., an encoder 210a, 210b, . . . , or 210n) with the respective input image as input constructs each initial feature map. Each initial feature map is lifted using the depth map into a frustum (e.g., frustum 230a, 230b, . . . , or 230n).

At 420, the model 200 constructs a sparse feature point cloud 240 including a plurality of features determined using the plurality of initial feature maps 215a, 215b, . . . , 215n. Features of each of the plurality of initial feature maps 215a, 215b, . . . , 215n corresponding to a depths that are within at least one range of depths are used to fill entries in a respective one of the frustums 230a, 230b, . . . , 230n, which are intermediate 3D structures. The depths of the features of the initial feature maps 215a, 215b, . . . , 215n are indicated by the incorporated depth data.

At 430, the model 200 transforms (e.g., through the voxelization function 250) the at least one of sparse feature point cloud 240 into a plurality of multi-resolution sparse grids including the sparse grids 255a, 255b, . . . , 255n. Each of the multi-resolution sparse grids includes a plurality of voxels. In some examples, a first multi-resolution sparse grid 255a includes a first voxel size (e.g., 1024³ voxels for a 3D scene) corresponding to a first granularity. A second multi-resolution sparse grid 255b includes a second voxel size (e.g., 256³ voxels for a 3D scene) corresponding with a second granularity.

At 440, the model 200 models, using a plurality of neural networks (e.g., the CNNs 260a, 260b, . . . , 260n) according to a hierarchal architecture (e.g., the multi-resolution or multi-granularity architecture), the multi-resolution sparse grids 255a, 255b, . . . , 255n to construct a hierarchical volume representation. In some examples, a first neural network (e.g., CNN 260a) of the plurality of neural networks processes the first multi-resolution sparse grid 255a at the first voxel size. A second neural network (e.g., CNN 260b) of the plurality of neural networks processes the second multi-resolution sparse grid 255b at the second voxel size.

At 450, the model 200 generates constructed content (e.g., the output image 285) based on the volume rendering 270 of the hierarchical volume representation. For example, the volume rendering 270 of the hierarchical volume representation constructs a new feature map (e.g., the volume-rendered feature map 275). The new feature map includes a 2D projection of the hierarchical volume representation with respect to a target capture device (e.g., the target pose of a target camera). Providing the constructed content based on the hierarchical volume representation includes decoding the new feature map using a decoder neural network (e.g., the decoder 280).

The volume-rendered feature map 275 includes a first component corresponding to a first level of the hierarchal architecture and a second component corresponding to a second level of the hierarchal architecture. The vectors for a plurality of features constructed by the plurality of neural networks (e.g., the CNNs 260a, 260b, . . . , 260n) are combined to construct the hierarchical volume representation.

In some examples, the method 400 further includes determining and updating a hierarchical encoder to reduce dimensionality of each voxel hierarchical level of a hierarchical voxel representation and output the hierarchical voxel representation into compressed latent variables. In some examples, the method 400 further includes determining and updating a multi-layer neural network by querying a subset of the plurality of voxels using coordinates. The plurality of features in the hierarchical volume representation is matched. A compressed representation of the hierarchical volume representation is outputted. In some examples, determining of the hierarchical encoder and the multi-layer neural network includes a first stage corresponding to compression of each voxel hierarchical level and a second stage correspond to compression of the hierarchical voxel representation into a final latent representation. In some examples, the plurality of neural networks includes a plurality of diffusion models. The plurality of diffusion models is used to model the plurality of voxels to construct the hierarchical volume representation.

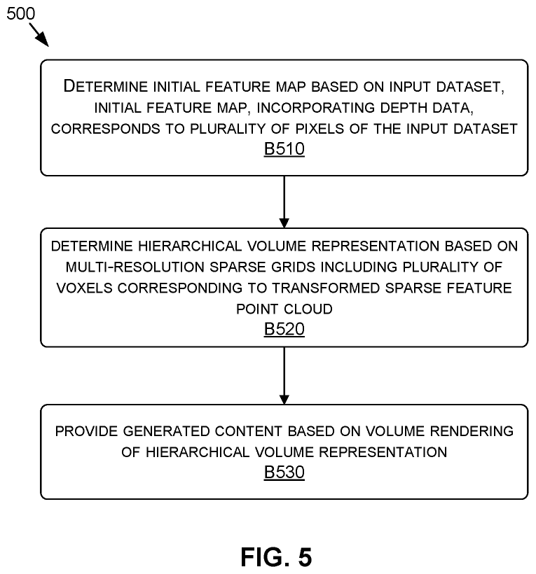

FIG. 5 is a block diagram of an example of a method 500 for deploying a machine learning model (e.g., the model 200) to construct output image 285. Each block of the method 500, described herein, can include one or more types of data or one or more types of computing processes that may be performed using any combination of hardware, firmware, and/or software. For instance, various functions may be carried out by a processor executing instructions stored in memory. The method 500 can also be embodied as computer-usable instructions stored on computer storage media. The method 500 can be provided by a standalone application, a service or hosted service (standalone or in combination with another hosted service), or a plug-in to another product, to name a few. In addition, the method 500 is described, by way of example, with respect to the system of FIG. 1 (e.g., the model 102 and 180) and FIG. 2 (e.g., the model 200). However, the method 500 can additionally or alternatively be executed by any one system, or any combination of systems, including, but not limited to, those described herein.

At 510, the model 200 determines an initial feature map 215a, 215b, . . . , or 215n based on an input dataset 202. The initial feature map, incorporating depth data (e.g., depth map 225a, 225b, or 225n), corresponds to a plurality of pixels of the input dataset 202. At 520, the model 220 determines a hierarchical volume representation based on multi-resolution sparse grids 225a, 225b, . . . , 225n including a plurality of voxels corresponding to a transformed sparse feature point cloud 240. At 530, the model 200 provides constructed content (e.g., the output image 285) based on volume rendering 270 of the hierarchical volume representation.

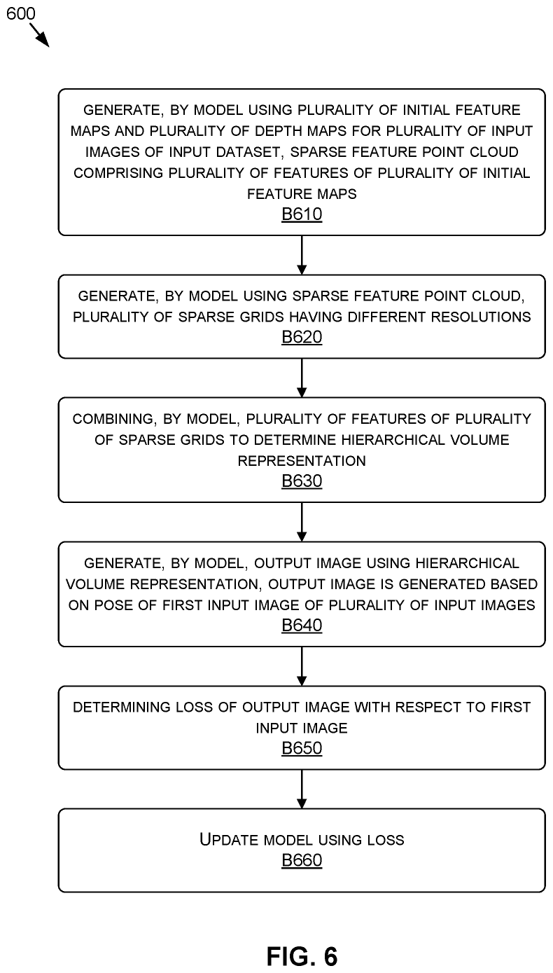

FIG. 6 is a block diagram of an example of a method 600 for training (e.g., updating) a machine learning model (e.g., the model 200) to construct output image 285. Each block of the method 600, described herein, can include one or more types of data or one or more types of computing processes that may be performed using any combination of hardware, firmware, and/or software. For instance, various functions may be carried out by a processor executing instructions stored in memory. The method 600 can also be embodied as computer-usable instructions stored on computer storage media. The method 600 can be provided by a standalone application, a service or hosted service (standalone or in combination with another hosted service), or a plug-in to another product, to name a few. In addition, the method 600 is described, by way of example, with respect to the system of FIG. 1 (e.g., the model 102 and 180) and FIG. 2 (e.g., the model 200). However, the method 600 can additionally or alternatively be executed by any one system, or any combination of systems, including, but not limited to, those described herein.

At 610, the model 200 constructs using a plurality of initial feature maps 215a, 215b, . . . , 215n and a plurality of depth maps 225a, 225b, . . . , 225n for a plurality of input images 204a, 204b, . . . , 204n of an input dataset 202, a sparse feature point cloud 240 including a plurality of features of the plurality of initial feature maps.

At 620, the model 200 constructs using the sparse feature point cloud 240 a plurality of sparse grids 255a, 255b, . . . , 255n having different resolutions. At 630, the model 200 combines a plurality of features of the plurality of sparse grids 255a, 255b, . . . , 255n to determine a hierarchical volume representation.

At 640, the model 200 constructs an output image 285 using the hierarchical volume representation. The output image 285 is constructed based on a pose of a first input image (e.g., input image 204a) of the plurality of input images 204a, 204b, . . . , 204n. The model 200 includes a decoder 280 to decode the new feature map to construct the output image 285.

At 650, the training system determines a loss of the output image 285 with respect to the first input image. At 660, the training system updates the model 200 using the loss. In some examples, the loss includes reconstruction loss.

In some examples, features of the plurality of initial feature maps corresponding to depths within at least one range of depths are used to fill entries in a respective one of a plurality of frustums, the depths of the features of each of the plurality of initial feature are indicated by a respective one of the plurality of depth maps.

In some examples, the plurality of sparse grids includes a first multi-resolution sparse grid 255a having a first voxel size and a second multi-resolution sparse grid 255b having a second voxel size. In some examples, the model 200 includes a first neural network (e.g., CNN 260a) of the plurality of neural networks to process the first multi-resolution sparse grid 255a at the first voxel size and a second neural network (e.g., CNN 260b) of the plurality of neural networks processes the second multi-resolution sparse grid 255b at the second voxel size.

In some examples, the model 200 constructs a new feature map 275 via volume rendering 270 of the hierarchical volume representation. The new feature map includes a 2D projection of the hierarchical volume representation corresponding with a target capture device at the pose. In some examples, the new feature map includes a first component corresponding to a first level of the hierarchal architecture and a second component corresponding to a second level of the hierarchal architecture. The method 600 further includes combining vectors for a plurality of features constructed by a plurality of neural networks 260a, 260b, . . . , 260n to construct the hierarchical volume representation.

In some examples, the model 180 or 200 can be implemented in or the application system 150 can include one or more systems such as automotive systems having control systems for an autonomous or semi-autonomous machine (e.g., an AI driver, an in-vehicle infotainment system, and so on) and/or a perception system (e.g., sensor systems and so on) for an autonomous or semi-autonomous machine, systems implemented using a robot, aerial systems, medical systems, boating systems, smart area monitoring systems, systems for performing deep learning operations, systems for performing simulation operations, systems for generating or presenting VR content, AR content, and/or MR content, systems for performing digital twin operations, systems implemented using an edge device, systems incorporating one or more VMs, systems for performing synthetic data generation operations, systems implemented at least partially in a data center, systems for performing conversational AI operations, systems for performing generative AI operations, systems implementing one or more language models—such as one or more LLMs, systems implementing vision language models (VLMs), systems for hosting real-time streaming applications, systems for performing light transport simulation, systems for performing collaborative content creation for 3D assets, systems implemented at least partially using cloud computing resources, and/or other types of systems.

### Example Computing Device

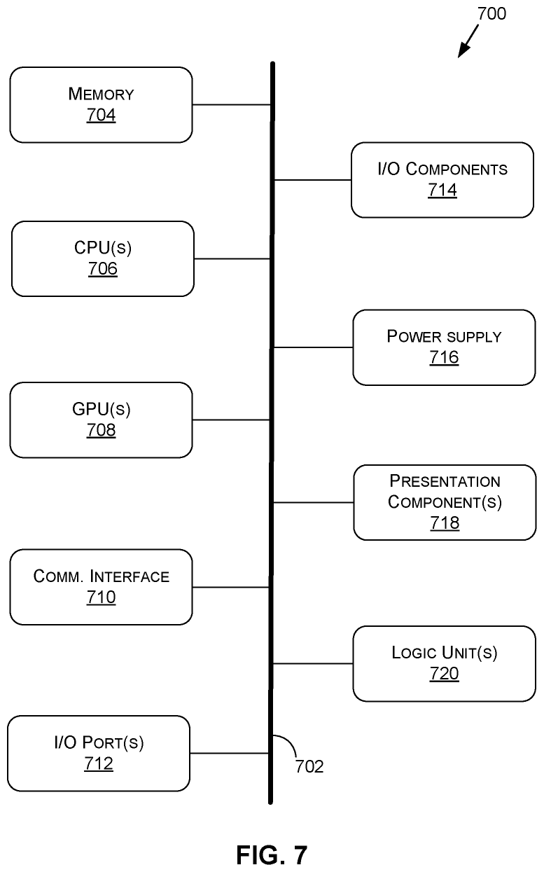

FIG. 7 is a block diagram of an example computing device(s) 700 suitable for use in implementing some embodiments of the present disclosure. The computing device(s) 700 are example implementations of the training system 100 and/or the application system 150. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more VMs, and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). In other words, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCle link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may construct pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may construct pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708. Examples of the logic unit(s) 720 include the model 102, the training system 100, the data processor 172, the dataset generator 176, the model 180, the application system 150, and so on.

Examples of the logic unit(s) 720 include one or more processing cores and/or components thereof, such as Data Processing Units (DPUs), Tensor Cores (TCs), Tensor

Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCle) elements, and/or the like.

The communication interface 710 may include one or more receivers, transmitters, and/or transceivers that enable the computing device 700 to communicate with other computing devices via an electronic communication network, included wired and/or wireless communications. The communication interface 710 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may enable the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The computing device 700 may be include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that enable detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to enable the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

### EXAMPLE DATA CENTER

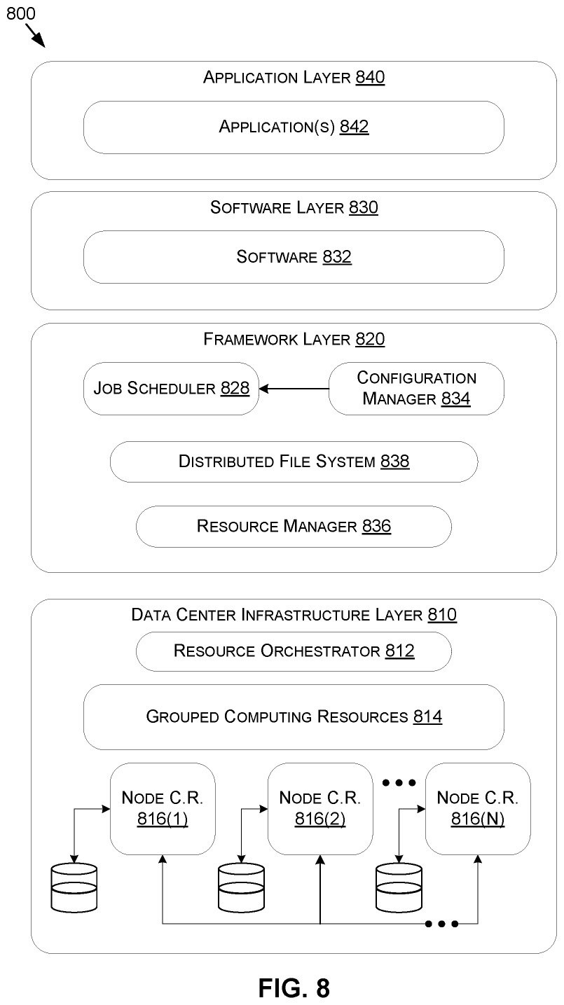

FIG. 8 illustrates an example data center 800 that may be used in at least one embodiments of the present disclosure, such as to implement the training system 100 or the application system 150 in one or more examples of the data center 800. The data center 800 may include a data center infrastructure layer 810, a framework layer 820, a software layer 830, and/or an application layer 840.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (CPUs) or other processors (including DPUs, accelerators, field programmable gate arrays (FPGAs), graphics processors or GPUs, etc.), memory devices (e.g., dynamic read-only memory), storage devices (e.g., solid state or disk drives), network input/output (NW I/O) devices, network switches, VMs, power modules, and/or cooling modules, etc. In some embodiments, one or more node C.R.s from among node C.R.s 816(1)-816(N) may correspond to a server having one or more of the above-mentioned computing resources. In addition, in some embodiments, the node C.R.s 816(1)-816(N) may include one or more virtual components, such as vGPUs, vCPUs, and/or the like, and/or one or more of the node C.R.s 816(1)-816(N) may correspond to a virtual machine (VM).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 828, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark (hereinafter “Spark”) that may utilize distributed file system 838 for large-scale data processing (e.g., “big data”). In at least one embodiment, job scheduler 828 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 828. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments, such as to perform training of the model 102 and/or operation of the model 180.

In at least one embodiment, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to train one or more machine learning models (e.g., train the model 102) or predict or infer information using one or more machine learning models (e.g., the model 180) according to one or more embodiments described herein. For example, a machine learning model(s) may be trained by calculating weight parameters according to a neural network architecture using software and/or computing resources described above with respect to the data center 800. In at least one embodiment, trained or deployed machine learning models corresponding to one or more neural networks may be used to infer or predict information using resources described above with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area

Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments-in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A system comprising at least one processor, the at least one processor comprising one or more circuits to:
construct at least one initial feature map of a plurality of initial feature maps based on a respective input image of an input dataset, wherein each of the at least one initial feature maps incorporates depth data of the respective input image and corresponds to a plurality of pixels of the respective input image;
construct a sparse feature point cloud comprising a plurality of features determined using the plurality of initial feature maps;
transform the sparse feature point cloud into multi-resolution sparse grids, at least one of the multi-resolution sparse grids comprising a plurality of voxels;
model, using a plurality of neural networks and according to a hierarchal architecture, the multi-resolution sparse grids to construct a hierarchical volume representation; and
generate constructed content based on the hierarchical volume representation.

2. The system of claim 1, wherein the input dataset comprises a plurality of input images of a 3D scene, and wherein features of the plurality of initial feature maps corresponding to depths within at least one range of depths are used to fill entries in a respective one of a plurality of frustums, the depths of the features being indicated by incorporating the depth data.

3. The system of claim 1, wherein a first multi-resolution sparse grid of the multi-resolution sparse grids comprises a first voxel size, and a second multi-resolution sparse grid of the multi-resolution sparse grids comprises a second voxel size.

4. The system of claim 3, wherein the hierarchal architecture comprises:
a first neural network of the plurality of neural networks processes the first multi-resolution sparse grid at the first voxel size; and
a second neural network of the plurality of neural networks processes the second multi-resolution sparse grid at the second voxel size.

5. The system of claim 1, wherein generating the constructed content further comprises:
determining a new feature map via volume rendering of the hierarchical volume representation, wherein the new feature map comprises a two-dimensional (2D) projection of the hierarchical volume representation corresponding with a target capture device.

6. The system of claim 5, wherein the new feature map comprises:
a first component corresponding to a first level of the hierarchal architecture;
a second component corresponding to a second level of the hierarchal architecture; and
the method further comprises combining vectors for a plurality of features constructed by the plurality of neural networks to construct the hierarchical volume representation.

7. The system of claim 5, wherein generating the constructed content based on the hierarchical volume representation comprises decoding the new feature map using a decoder neural network.

8. The system of claim 1, further comprising:
determining, using a depth encoder with the respective input image as input, a depth map of the respective input image;
determining, using a feature encoder with the respective input image as input, each initial feature map; and
lifting each initial feature map using the depth map into a frustum.

9. The system of claim 1, the at least one processor further to:
construct and update a hierarchical encoder to reduce dimensionality of at least one voxel hierarchical level of a hierarchical voxel representation and output the hierarchical voxel representation into compressed latent variables;
construct and update a multi-layer neural network by querying a subset of the plurality of voxels using coordinates, wherein updating comprises matching the plurality of features in the hierarchical volume representation and outputting a compressed representation of the hierarchical volume representation; and
wherein the determining of the hierarchical encoder and the multi-layer neural network comprises:
a first stage corresponding to compression of each voxel hierarchical level; and
a second stage correspond to compression of the hierarchical voxel representation into a final latent representation.

10. The system of claim 9, wherein the plurality of neural networks comprise a plurality of diffusion models, and wherein the modeling comprises using the plurality of diffusion models to model the plurality of voxels to construct the hierarchical volume representation.

11. The system of claim 1, wherein the at least one processor is comprised in at least one of:
a control system for an autonomous or semi-autonomous machine;
a perception system for an autonomous or semi-autonomous machine;
a system implemented using a robot;
an aerial system;
a medical system;
a boating system,
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system implementing large language models (LLMs);
a system implementing vision language models (VLMs);
a system for hosting one or more real-time streaming applications;
a system for performing light transport simulation;
a system for performing collaborative content creation for 3D assets; or
a system implemented at least partially using cloud computing resources.

12. A system comprising at least one processor, the at least one processor comprises one or more circuits to:
determine an initial feature map based on an input dataset, wherein the initial feature map, incorporating depth data, corresponds with a plurality of pixels of the input dataset;
determine a hierarchical volume representation based on multi-resolution sparse grids comprising a plurality of voxels corresponding to a transformed sparse feature point cloud; and
provide constructed content based on volume rendering of the hierarchical volume representation.

13. A system comprising at least one processor, the at least one processor comprises one or more circuits to:
construct, by a model using a plurality of initial feature maps and a plurality of depth maps for a plurality of input images of an input dataset, a sparse feature point cloud comprising a plurality of features of the plurality of initial feature maps;
construct, by a model using the sparse feature point cloud, a plurality of sparse grids having different resolutions;
combine, by a model, a plurality of features of the plurality of sparse grids to determine a hierarchical volume representation;
construct, by a model, an output image using the hierarchical volume representation, wherein the output image is constructed based on a pose of a first input image of the plurality of input images;
determine a loss of the output image with respect to the first input image; and
update the model using the loss.

14. The system of claim 13, wherein the loss comprises reconstruction loss.

15. The system of claim 13, wherein features of each of the plurality of initial feature maps corresponding to depths within at least one range of depths are used to fill entries in a respective one of a plurality of frustums, the depths of the features of each of the plurality of initial feature are indicated by a respective one of the plurality of depth maps.

16. The system of claim 13, wherein the plurality of sparse grids comprises:
a first multi-resolution sparse grid having a first voxel size; and
a second multi-resolution sparse grid having a second voxel size.

17. The system of claim 16, wherein the model comprises:
a first neural network of the plurality of neural networks to process the first multi-resolution sparse grid at the first voxel size; and
a second neural network of the plurality of neural networks to process the second multi-resolution sparse grid at the second voxel size.

18. The system of claim 13, further comprising determining a new feature map via volume rendering of the hierarchical volume representation, wherein the new feature map comprises a two-dimensional (2D) projection of the hierarchical volume representation corresponding with a target capture device at the pose.

19. The system of claim 18, wherein
the new feature map comprises:
a first component corresponding to a first level of the hierarchal architecture;
a second component corresponding to a second level of the hierarchal architecture; and
the method further comprises combining vectors for a plurality of features constructed by a plurality of neural networks to construct the hierarchical volume representation.

20. The system of claim 18, further comprising decoding the new feature map using a decoder neural network.
